(19) United States
(12) Patent Application Publication
(10) Pub. No.: US 2006/0218578 A1
(43) Pub. Date: Sep. 28, 2006

(54) Integrated offline product branding method

(76) Inventors: Amy Kyle, Greensboro, NC (US); Fredrick W. Harrison JR., Winston Salem, NC (US)

Correspondence Address: NEXSEN PRUETT JACOBS & POLLARD, 201 W MCBEE AVENUE, SUITE 400, GREENVILLE, SC, 29601, US

(21) Appl. No.: 11/387,112

(22) Filed: Mar. 22, 2006

Related U.S. Application Data
(60) Provisional application No. 60/664,810, filed on Mar. 24, 2005.

(51) Int. Cl. H04N 7/10

(52) U.S. Cl. 725/32

(57) ABSTRACT

An improved method for advertising which provides synergism between published media and broadcast media. The method includes forming a video wherein the video has items of commerce in at least one frame. Capturing the frame. Annotating the captured frame with at least one product attribute of the item thereby forming a publication image. Publishing the publication image and broadcasting the video.

### CROSS-REFERENCE TO RELATED APPLICATIONS

The present application claims priority to U.S. Provisional Application No. 60/664,810 filed Mar. 24, 2005 which is pending and incorporated herein by reference.

### BACKGROUND OF THE INVENTION

The present invention is directed to an integrated offline product branding method wherein branded products utilized in video scenes are separately branded in print media or on the internet preferably prior to broadcast.

The ongoing availability and utilization of technology in the entertainment arena has minimized the effectiveness of spot commercials played during a broadcast. In past decades television shows were interspersed with commercials for a large variety of items of commerce. The consumer had very few options for avoiding the commercial with the limited exceptions being physically leaving the vicinity or turning off the video and/or audio. This was typically not done so advertisers could almost guarantee that the advertisement was receiving virtually the same percentage of the viewing audience as the underlying broadcast.

Recorders, such as video cassette recorders (VCR), slightly decreased the number of viewers for the commercials since viewers could record the broadcast for later replay with the option to fast-forward through the commercials. The effort involved in recording and replaying the show did not drastically reduce the ratio of commercial viewers relative to broadcast viewers.

Consumers now have access to many more modes of entertainment and many more broadcast options. Instead of a few channels the consumer can not select between hundreds of channels thereby increasing the competition for any given broadcast and further eroding the percentage of the viewing population being reached by any given commercial. This problem has been exasperated by the introduction of digital recording equipment, such as TiVo and digital video recorders, wherein the ease of operation relative to analog recorders has greatly increased the overall use. It is estimated that by the year 2008 TiVo and digital video recorders will have achieved a 20% market penetration and that by 2010 this will increase to 40%. The net result is a continued erosion in the effectiveness of commercials that are interspersed with broadcast. This trend is expected to continue without abatement.

In an effort to combat the erosion advertisers have begun placing products in prominent locations as part of the broadcast show. It is now not uncommon to see actors in a broadcast mention products as part of the dialogue or to insure that the label of a product is readily visible to the viewing audience. This technique of embedding products, referred to as branding or integration, provides the advertiser with some level of certainty that the viewing audience for the embedded advertisement is the same as that of the underlying broadcast. The effectiveness of this method is limited. First, the creativeness of the broadcast is hindered by the contractual requirement of showcasing a product. It is often difficult to include a statement, or demonstration, of the desirability of a product within the context of the broadcast without losing the underlying theme and continuity of the conversation or action. Furthermore, the viewer has a limited opportunity to make a purchasing decision since it is virtually impossible to get the full benefit of a commercial including how or where to purchase the product and other assorted information such as the manufacturer, related products, options, contraindications and the like.

More recently efforts have been undertaken to utilize “interactive technology” wherein a viewer can access information about items within the scene of a broadcast by either accessing previously stored information or by accessing the internet through a parallel or integrated server. If, for example, a viewer sees a particular clothing item on a favorite actor or actress the viewer has the option to inquire further into the item and possibly execute a purchase or be led to images wherein the purchase can be made through the internet. This technology has a disadvantage in that the viewer has no prior expectation of the product appearing. If a viewer is interested in a particular item, or prop, by the time they realize their interest the product may be no longer in view and the viewer fails to capture the pertinent purchasing information. In essence, the advertiser has lost the impulse buying opportunity and these are seldom recovered.

In spite of the advancements in the art there are still ongoing desires to increase brand awareness and product desire through effective advertising. In particular, the art has been lacking a method for enticing viewers to seek opportunities to view and purchase products either through interactive techniques or directly.

### SUMMARY OF THE INVENTION

It is an object of the present invention to provide a method for increasing brand awareness by integrating enticements from print media and the internet with broadcast views demonstrating and illustrating the branded product.

It is another object of the present invention to entice broadcast viewers by correlating broadcast with branded products.

A particular feature of the present invention is the ability to create synergism between publications and broadcast thereby increasing the advertising opportunities of each.

These and other objects, as will be realized, are provided in a method for advertising. The method includes forming a video wherein the video has items of commerce in at least one frame. Capturing the frame. Annotating the captured frame with at least one product attribute of the item thereby forming a publication image. Publishing the publication image and broadcasting the video.

Yet another embodiment is provided in a system for advertising. They system has a video wherein the video comprises at least one frame with at least one item displayed therein. A publication image is provided with the frame and a display window with at least one product attribute of the item.

Yet another embodiment is provided in a method for advertising. The method includes forming a frame wherein the frame has at least one item of commerce illustrated therein. The frame is annotated with at least one product attribute of the item thereby forming a publication image. The publication image is published and the video is broadcast.

Yet another embodiment is provided in A system for advertising. The system has a frame with at least one item displayed therein and a publication image with the frame and a display window with at least one product attribute of the item.

### BRIEF DESCRIPTION OF FIGURES

FIG. 1 illustrates components of the present invention.

FIG. 2 illustrates an optional, and preferred, component of the present invention.

FIG. 3 is a flow chart illustration of the method of the present invention.

FIG. 4 is a reproduction of a print media representation of an embodiment of the invention.

FIG. 5 is a reproduction of a internet based representation of an embodiment of the invention.

### DETAILED DESCRIPTION OF THE INVENTION

The present invention will be described with reference to the various figures forming an integral part of the instant specification.

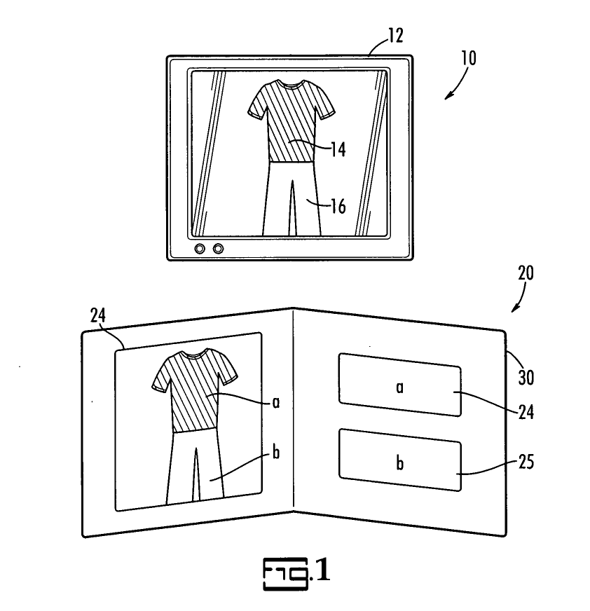

The preferred components of the present invention are illustrated in FIG. 1. In FIG. 1, a frame of a scene of a video broadcast is indicated at 10 appearing on a screen, 12. The frame comprises a multiplicity of items. The first item, 14, indicated herein as a shirt, and second item, 16, indicated as pants, are items that may be of interest to a viewer. While indicated as clothing the item may be any item, consumable, wearable, durable or otherwise which could be of interest to a viewer. A separately distributed media, 20, in the form of print media, 22, comprises the frame, 24, with annotation such that product attributes of the item of interest can be obtained. In the example of FIG. 1, the shirt is annotated with an “a” and the pants are annotated with a “b”. In a further embodiment, detail windows, 24 and 26, provide additional information such as product attributes. One detail window, 24 for example, may include product attributes which are details and further characterization of the product such as the purchase information, color, size, available options, availability, website contact, company contact, contraindications, disclaimers, logos, slogans or any other information typically included in an audio, video or print advertisement. A second detail window, 26 for example, may include information which correlates the particular item to the broadcast. For example the show, date, time, channel or network may be included such that a person viewing the item with interest will be alerted to an opportunity to see the actual item in a broadcast.

A particular advantage of the correlated print media and broadcast is the opportunity to entice the viewer of the print media to view the broadcast. Conversely, a broadcast viewer realizing that more details of the items are available will be enticed to purchase, or subscribe to, the print media. The advertiser therefore multiplies the opportunities for interest due to the synergism created by the print media and broadcast.

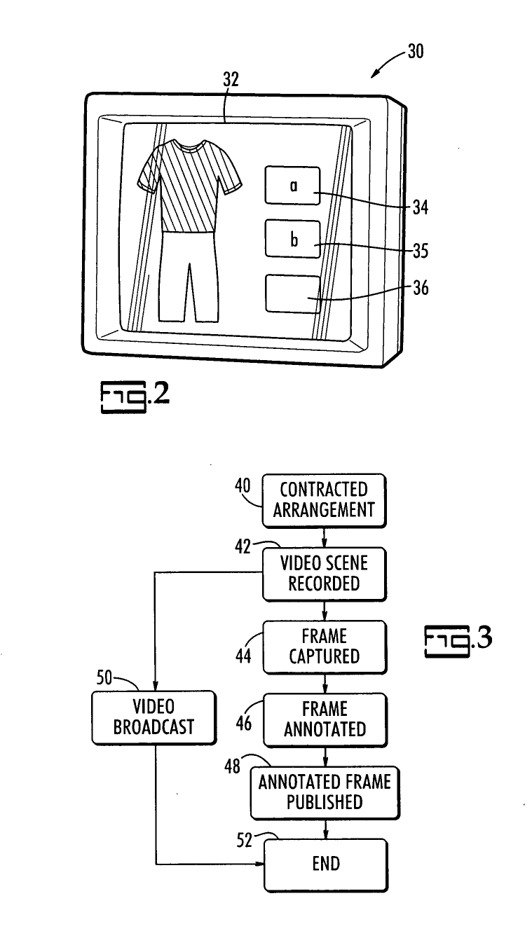

FIG. 2 illustrates a preferred embodiment of the present invention. In FIG. 2, the media is a computer terminal, 30, with a website image, 32, thereon. The website presents the frame with annotation in a manner directly analogous to the print media. Icons, 34-36, which may be interactive provide additional information related to the item of commerce. The icon may include all pertinent information such as purchase information, color, size, available options, availability, company contact, contraindications, disclaimers, logos, slogans or any other information typically included in an audio, video or print advertisement. The icon may also direct the user to a purchase opportunity as commonly done in internet based commerce. In the present non-limiting example icon 34 is specific to the details of item “a” whereas icon 35 is specific to the details of item “b”. Icon 36 may be a navigational icon which, when engaged by the user, returns the user to a previous webpage, advances to additional products, advances to a purchase closure screen, or any other navigational tool useful for internet communication.

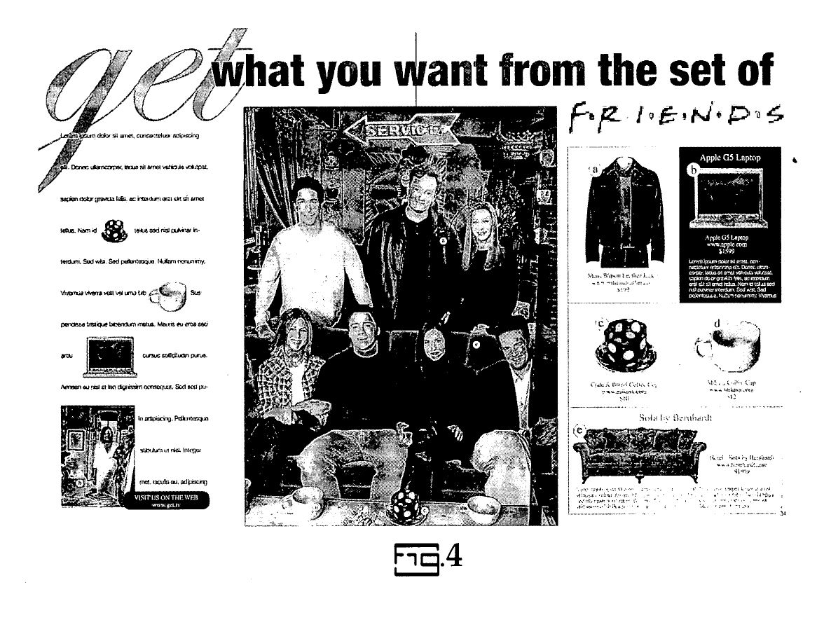

The preferred method of commerce for the present invention is illustrated in FIG. 3. In FIG. 3, a contractual arrangement is established at 40 wherein the product sponsor, the creator of the video scene and the creator of the publication determine the compensation parameters associated with the advertising relationship. For the purposes of the present invention the details of the parameters are not limited and the product sponsor, the creator of the video scene and the creator of the publication may be the same entity, separate entities or a combination thereof. At 42, a video is prepared wherein at least one scene of the video comprises an image of the advertised item. The frame comprising the advertised item is captured at 44. The frame is annotated at 46 with any additional information which may be of interest to the viewer such as a correlation to the video broadcast. The annotated frame is published as print media or on the internet at 48. In a parallel process the video is broadcast at 50. In a particularly preferred embodiment the broadcast occurs after the annotated frame is published thereby allowing the broadcast information to be included with the publication. After the publication and viewing is complete the method ends at 52.

It would be apparent that the entire frame, or a portion of the frame, may be used. For example, the video frame may be cropped to better fit the publication format or a portion of the frame may be used such as only the item being advertised preferably with a sufficient amount of the scene to provide a context. The frame may also be a representative frame of the show which may, or may not, actually appear in a broadcast but which clearly represents the broadcast.

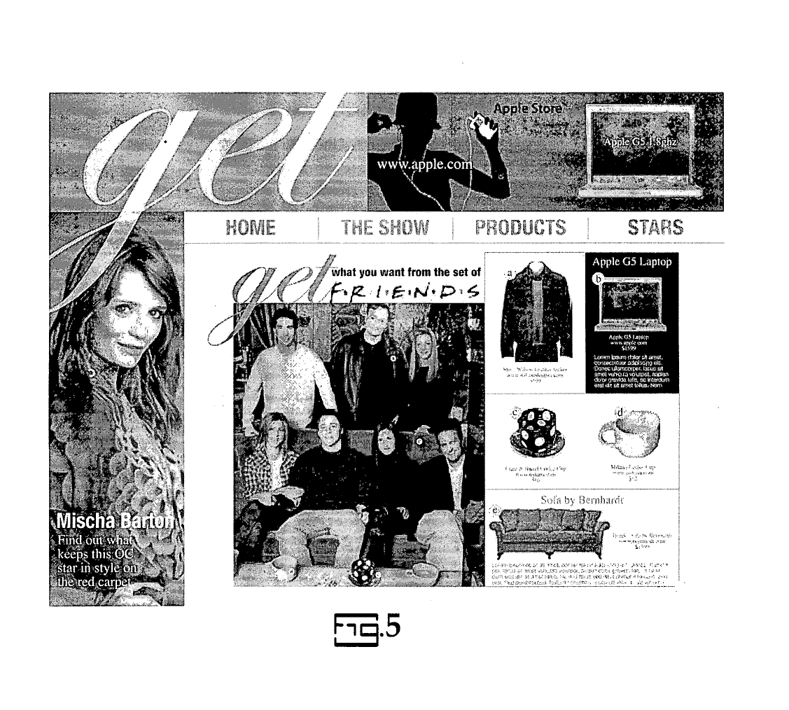

FIG. 4 is a representative print version of the publication. In the publication certain items of potential interest have annotation both in the form of an indicia on the frame and in the form of a reproductive view of the item from the frame.

FIG. 5 is a representative internet web site view of the publication. As in the print version items of potential interest are annotated in the form of indicia on the frame and in the form of a reproduced or representative view of the item from the frame. The image may itself be an icon thereby allowing the user to click on the item to be directed to further information from the web site.

For the purposes of the present invention the broadcast includes all methods of displaying video images on a screen. The broadcast can be transmitted in real time such as in a television broadcast or it may be transmitted for viewing at select times at the discretion of the operator or viewer. The broadcast can be transmitted through terrestrial, cable, twisted copper or optical transmission methods or the image can be provided on analog or digital media. The broadcast includes those broadcast which are available to the public through publicly available transmission methods, free or otherwise, or it may include broadcast which have limited availability such as movie theaters and the like.

For the purposes of the present invention the screen is a surface upon which a broadcast is projected or otherwise visible. Included are phosphor based screens, plasma based screens and front or rear projection screens.

For the purposes of the present invention a computer terminal is a collection of input devices and output devices wherein the input devices send a command to a network, preferably the world wide web, and the output device receives and displays images and information responsive to the command.

For the purposes of the present invention a website is a set of stored information retrievable over a network by a computer terminal.

For the purposes of the present invention icons are images on a computer terminal which can be visualized and/or addressed by a computer terminal to direct the user to a specific stored image on a website.

Frame capture techniques are not limited herein and any technique used to capture a frame from an analog or digital video to transfer that frame to a fixed image is suitable for use herein whether that technique is analog or digital.

The present invention has been described with particular reference to the preferred embodiments. One of skill in the art would realize additional embodiments without departing from the metes and bounds of the present invention as more specifically set forth in the claims appended hereto.

Claimed is:

1. A method for advertising comprising:
forming a video wherein said video has items of commerce in at least one frame of said video;
capturing said frame;
annotating said captured frame with at least one product attribute of said item thereby forming a publication image;
publishing said publication image;
broadcasting said video.

2. The method for advertising of claim 1 wherein said publishing is prior to said broadcasting.

3. The method for advertising of claim 1 wherein said publication image is a printed image.

4. The method for advertising of claim 1 wherein said publication image is an internet image.

5. The method for advertising of claim 4 further comprising at least one icon.

6. The method of advertising of claim 1 wherein said product attribute comprises at least one selected from a group consisting of purchase information, color, size, available options, availability, website contact, company contact, contraindications, disclaimers, logos and slogans.

7. The method of advertising of claim 1 wherein said annotating comprises placing an indicia on said frame.

8. A system for advertising comprising:
a video wherein said video comprises at least one frame with at least one item displayed therein;
a publication image comprising:
said frame; and
a display window comprising at least one product attribute of said item.

9. The system for advertising of claim 8 wherein said publication image is a printed image.

10. The system for advertising of claim 8 wherein said publication image is an internet image.

11. The system for advertising of claim 10 further comprising at least one icon.

12. The system for advertising of claim 8 wherein said product attribute comprises at least one selected from the group consisting of purchase information, color, size, available options, availability, website contact, company contact, contraindications, disclaimers, logos and slogans.

13. The system for advertising of claim 8 further comprising at least one indicia on said frame.

14. A method for advertising comprising:
forming a frame wherein said frame has at least one item of commerce;
annotating said frame with at least one product attribute of said item thereby forming a publication image;
publishing said publication image;
broadcasting said video.

15. The method for advertising of claim 14 wherein said publishing is prior to said broadcasting.

16. The method for advertising of claim 14 wherein said publication image is a printed image.

17. The method for advertising of claim 14 wherein said publication image is an internet image.

18. The method for advertising of claim 17 further comprising at least one icon.

19. The method of advertising of claim 14 wherein said product attribute comprises at least one selected from a group consisting of purchase information, color, size, available options, availability, website contact, company contact, contraindications, disclaimers, logos and slogans.

20. The method of advertising of claim 14 wherein said annotating comprises placing an indicia on said frame.

21. A system for advertising comprising:
a frame with at least one item displayed therein;
a publication image comprising:
said frame; and
a display window comprising at least one product attribute of said item.

22. The system for advertising of claim 21 wherein said publication image is a printed image.

23. The system for advertising of claim 21 wherein said publication image is an internet image.

24. The system for advertising of claim 23 further comprising at least one icon.

25. The system for advertising of claim 21 wherein said product attribute comprises at least one selected from the group consisting of purchase information, color, size, available options, availability, website contact, company contact, contraindications, disclaimers, logos and slogans.

26. The system for advertising of claim 21 wherein said publication image further comprises at least one indicia on said frame.
